(19) United States
(12) Patent Application Publication
(10) Pub. No.: US 2024/0199129 A1
(43) Pub. Date: Jun. 20, 2024

(54) FRONT FACE FOR MOTOR VEHICLE

(71) Applicant: COMPAGNIE PLASTIC OMNIUM SE, LYON (FR)

(72) Inventors: Pierre MONTANVERT, Sainte-Julie (FR); Lionel RIVAL, Sainte-Julie (FR)

(73) Assignee: COMPAGNIE PLASTIC OMNIUM SE, LYON (FR)

(21) Appl. No.: 18/545,384

(22) Filed: Dec. 19, 2023

(30) Foreign Application Priority Data
Dec. 19, 2022 (FR) 2213844

(51) Int. Cl. B62D 25/08; B60Q 1/02; B60R 13/04; B62D 29/04

(52) U.S. Cl. CPC B62D 25/08; B60Q 1/02; B60R 13/04; B62D 29/043

(57) ABSTRACT

The front face for a motor vehicle includes: an upper portion including an upper panel and a trim module, a lower portion including a lower panel, an upper end of the lower panel being adjacent to a lower end of the upper panel, wherein the lower panel is configured to be movable in the direction of a rear of the vehicle, independently of the upper panel, during an impact at the second external surface of the lower portion.

### TECHNICAL FIELD

The present disclosure relates to a front face for a motor vehicle as well as a motor vehicle including such a front face.

### BACKGROUND

It is already known in the prior art, a motor vehicle including a front face, this front face including in particular a trim module that can integrate technical features, such as the presence of sensors or signaling members, and aesthetic features, such as members for diffusing light patterns. Such a trim module has a high added value and is expensive to manufacture and fragile. The arrangement of the trim module in the front face leads to significant exposure of said module to risks of damage, for example during the front impact of the vehicle.

During a low-speed impact or a small impact, such as impacts called “insurance” impacts, “parking” impacts, “repairability” impacts, the main objective is to reduce the repair costs and to protect the element or elements directly or indirectly undergoing the impact. A low-speed impact or a small impact are low-kinetic energy shocks, less than 1000 J. Typically, an “insurance” impact corresponds to an impact at about 15 km/h against a fixed wall, such as that known under the name Danner or AZT, or at about 8 km/h against a wall angle or against a post. A “parking” impact is an impact occurring at less than 8 km/h.

Thus, it is particularly desirable to prevent damage to the expensive trim module, in particular during a low-speed impact.

### SUMMARY OF THE PRESENT DISCLOSURE

The present disclosure in particular aims to reduce or prevent damage to a trim module, and more particularly to protect the expensive components that it contains, from a front face of a motor vehicle during an impact at the front face, more particularly during a low-speed impact.

To this end, the present disclosure relates to a front face for a motor vehicle including:
an upper portion having a first external surface visible from the outside of the vehicle and including an upper panel made of plastic material and a trim module including an electromagnetic waves diffusion member and an external surface transparent or translucent to said electromagnetic waves, the trim module being intended to be attached to a support structure of the vehicle,
a lower portion, having a second external surface visible from the outside of the vehicle and including a lower panel made of plastic material, an upper end of the lower panel being adjacent to a lower end of the upper panel, wherein the lower panel is configured to be movable in the direction of a rear of the vehicle, independently of the upper panel, during an impact at the second external surface of the lower portion.

Thus, during an impact, the lower panel that encounters an obstacle can be moved toward the rear of the vehicle without affecting the upper panel, and more generally without impacting the upper portion including the trim module. The risk of damaging, during an impact, the trim module included in the upper portion is thus reduced, in particular for small impacts and low-speed impacts. The risk of damaging the trim module during an impact is particularly reduced with a front face according to the present disclosure when the impactor has a height less than that of a lower end of the upper panel when the front face is mounted on a vehicle.

The present disclosure may include one or more of the following optional features, taken alone or in combination:

The bottom panel is configured to be movable over a stroke of 10 to 100 mm along the longitudinal axis of the vehicle, towards a rear of the vehicle, independently of the upper panel.

The upper end of the lower panel and the lower end of the upper panel form complementary deformable or breakable means of fastening the lower panel to the upper panel, configured to deform or break during an impact at the second external surface of the lower portion.

The upper end of the lower panel forms an undercut, the lower end of the upper panel being arranged in the undercut, at a distance and facing the upper end of the lower panel.

The upper end of the lower panel forms a groove and the lower end of the upper panel forms a tab arranged in the groove.

The lower end of the upper panel forms an undercut, the upper end of the lower panel being arranged in the undercut, at a distance and facing the lower end of the upper panel.

The lower end of the upper panel forms a groove and the upper end of the lower panel forms a tab arranged in the groove.

The groove and the tab extend in the same substantially horizontal plane when the front face is mounted on the vehicle.

The lower portion forms a protuberance relative to the upper portion at an external surface of the front face.

The front face further includes two optical units integrated into the trim module, the optical units being arranged respectively at two opposite lateral ends of the trim module.

The present disclosure also relates to a motor vehicle including a front face as described above.

### BRIEF DESCRIPTION OF THE FIGURES

The present disclosure will be better understood upon reading the following description, which is provided merely as example and with reference to the appended drawings, wherein:

FIG. 1 is a schematic perspective representation of a front part of a motor vehicle including a front face according to a first embodiment.

FIG. 2 is a schematic representation of different elements of the front face of the motor vehicle of FIG. 1.

FIG. 3 is a schematic side representation of a front part of the motor vehicle of FIG. 1.

FIG. 4 is an enlarged schematic representation of the part defined by the circle C of the motor vehicle of FIG. 3.

FIG. 5 is a representation similar to that of FIG. 4, showing the lower panel after or during an impact.

FIG. 6 is a representation similar to FIG. 1 of a front part of a motor vehicle according to a fourth embodiment.

FIG. 7 is a representation similar to FIG. 4 of a third embodiment.

FIG. 8 is a representation similar to FIG. 3 of a front part of a motor vehicle according to a fourth embodiment.

FIG. 9 is a representation similar to FIGS. 4 (A) and 5 (B) of the fourth embodiment.

### DETAILED DESCRIPTION

In the detailed description, the longitudinal direction (or X-axis), the transverse direction (or Y-axis) and the vertical direction (or Z-axis) refer to the directions of a motor vehicle and are shown the figures.

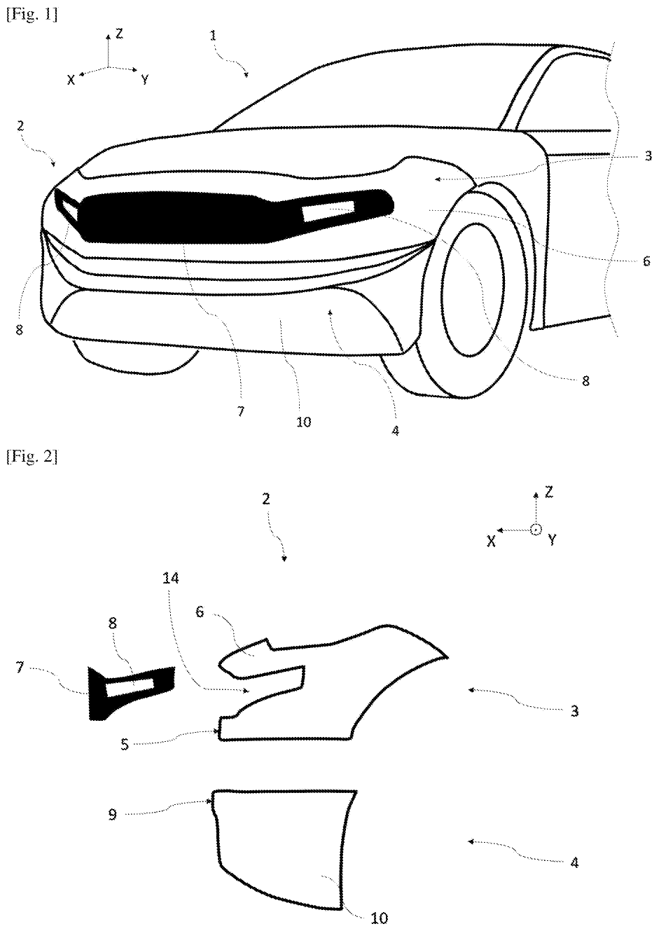

FIG. 1 shows the front part of a motor vehicle 1 that includes a front face 2 according to a first embodiment. According to an embodiment, “front face” is understood to mean the part or parts of the vehicle 1 delimiting an external surface visible from outside in front of the vehicle 1.

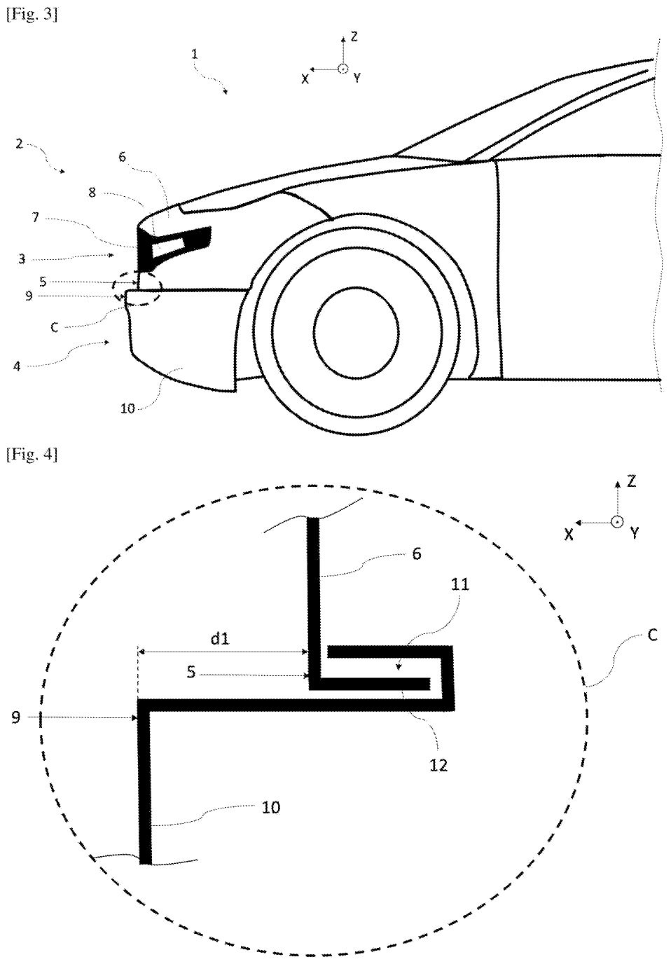

The front face 2 includes an upper portion 3 and a lower portion 4 ([FIG. 2]).

The upper portion 3 of the front face 2 has a first external surface 5 visible from the outside of the motor vehicle 1. The upper portion 3 includes an upper panel 6 and a trim module 7.

According to the first embodiment, the upper panel 6 is made of plastic material. It has a central orifice wherein the trim module 7 and the optical units 8 are mounted. In the present case, the two optical units 8 are integrated into the trim module 7 and are arranged respectively at two opposite lateral ends of the trim module 7. This integration of the optical units 8 into the trim module facilitates the mounting of the front face 2 on the motor vehicle 1 and improves the aesthetics of the vehicle 1 by making it possible, for example, to obtain a continuity of shape between the trim module 7 and the optical units 8.

The trim module 7 is arranged in such a way that its external surface is flush with the external surface of the upper panel 6. The external surface of the trim module 7 and the external surface of the upper panel 6 are in continuity of shape in order to create an effect giving the illusion that the upper portion 3 is a single piece.

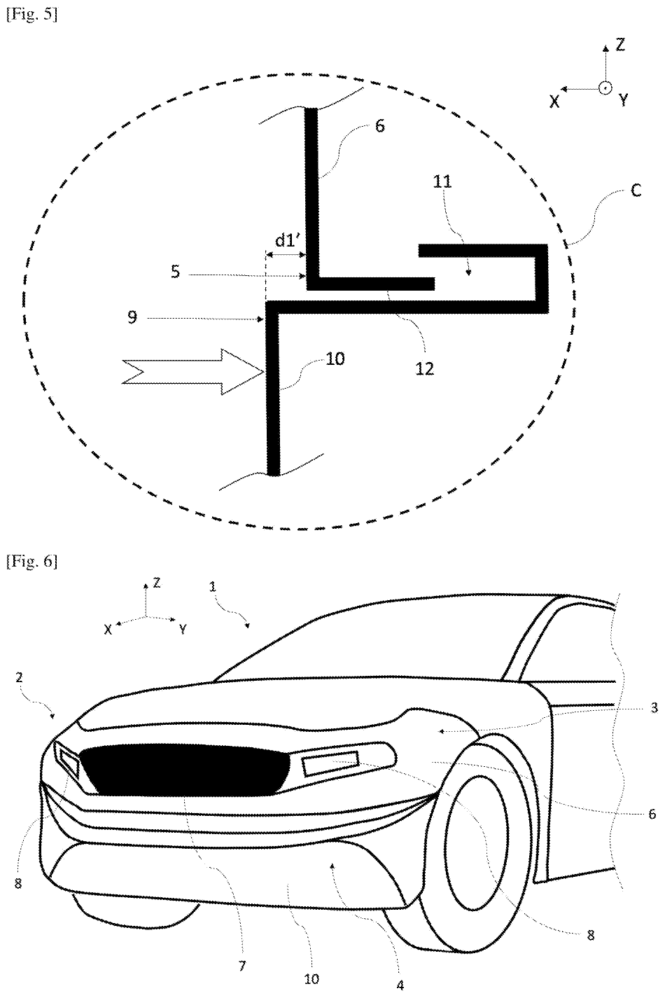

According to a second embodiment presented in [FIG. 6], the front face 2 differs in that the optical units 8 are not integrated into the trim module 7. The optical units 8 retain the same position on the vehicle 1 as in the first embodiment, so that the trim module 7, arranged between these optical units 8 is shorter than in the first embodiment.

In the first embodiment, the trim module 7 has a general elongated shape extending over more than 50% of the width of the front face 2. More particularly, in the present case, the trim module 7 extends over about 90% of the width—that is, the dimension along the transverse axis Y—of the front face 2. Of course, according to alternative embodiments, the trim module can extend across less than 50% or more than 90% of the front face. The trim module 7 is intended to be attached to a support structure of the motor vehicle 1, for example on the body of the motor vehicle 1 or on a front technical face of the vehicle 1.

The trim module 7 includes an electromagnetic waves scattering member. In the present case, this electromagnetic waves diffusion member is able to emit electromagnetic waves in the visible spectrum, commonly called light hereinafter. This diffusion member includes for example a light guide coupled to a light emitter (not shown). According to other embodiments, the electromagnetic waves scattering member is able to emit other types of electromagnetic waves, for example infrared waves or radio waves. Provision may be made for the trim module 7 to include multiple electromagnetic waves diffusion members, each member being able to diffuse one or more types of electromagnetic waves.

The trim module 7 further includes an external surface transparent or translucent to said electromagnetic waves. In the present case, the external surface is at least transparent or translucent to light. The trim module 7 is thus able to emit light outwardly through the external surface transparent or translucent to light in order, for example, to transmit a light signal. Furthermore, this light emission can also be used to improve the aesthetic appearance of the trim module 7. According to a particular embodiment, the external surface may optionally deflect electromagnetic waves, for example light. It is thus possible to advantageously provide an optical correction in front of the optical units 8.

The lower portion 4 has a second external surface 9 visible from the outside of the vehicle 1 when the front face 2 is mounted on the vehicle 1. The lower portion 4 in particular includes a lower panel 10 made, in the present case, of plastic material.

As shown in FIGS. 4 and 5, an upper end of the lower portion 4 and a lower end of the upper portion 3 are adjacent and offset horizontally along the longitudinal axis X of the vehicle 1, so that the upper end of the second external surface 9 of the lower portion 4 is located further toward the front of the vehicle 1 than the adjacent lower end of the first external surface 5 of the upper portion 3. This horizontal offset d1 is between 10 and 100 mm according to the embodiments, preferably between 20 and 80 mm ([FIG. 4]).

The horizontal offset d1 along the longitudinal axis X of the vehicle 1 between the lower portion 4 and the upper portion 3 of the front face 2 causes the upper portion 3 to be set back relative to the lower portion 4 (FIGS. 3 and 4). Thus, during a frontal impact, for example during a low-speed “parking” impact, the lower portion 4 of the front face 2 is the first part of the front face 2 to be subjected to the impact. Because the upper portion 3 is set back, it is not affected by the impact, at least during part of the impact. Consequently, the trim module 7 included in this upper portion 3 of the front face 2 is also not impacted by this impact. In this way, the risk of damage to the trim module 7 during an impact, in particular a “parking” impact, is reduced or even eliminated. Preferably, the front face 2 is configured so that the lower end of the upper portion 3 is located higher vertically (that is to say along the Z-axis) than the impactors that the vehicle 1 is likely to encounter, in particular during a “parking” impact. Since the trim module 7 is located in the upper portion 3, the risk that it is damaged during an impact, in particular during a “parking” impact, is further reduced.

The horizontal offset d1 included between 10 and 100 mm, preferably between 20 and 80 mm, is sufficiently large for the lower portion 4, during a parking impact, to absorb all or a majority of the deformation due to the impact, thus reducing or even eliminating the deformation received by the upper portion 3. In other words, the lower portion 4 forms a protuberance relative to the upper portion 3 at an external surface of the front face 2. The offset d1 can be adapted according to the embodiments, for example as a function of the impact absorption properties of the lower portion 4 of the front face 2.

Furthermore, as shown in [FIG. 5], the lower panel 10 is configured to be movable over a stroke of 10 to 100 mm, preferably 20 to 80 mm, in the direction of the rear of the vehicle 1, independently of the upper panel 6, during an impact at the second external surface 9. Thus, the lower panel 10 can absorb a greater part of the deformation due to the impact without this impacting the upper panel 6 of the upper portion 3. The risk of an impact damaging the trim module 7 in the upper panel 3 is thus reduced. In the particular case of an impact with low kinetic energy, it is possible for this kinetic energy to be sufficiently low not to cause the lower panel 10 to move but only to cause a slight local deformation.

It is understood that, during an impact, the lower panel 10 may be moved toward the rear of the vehicle 1 according to a movement at least partially including a component along the longitudinal axis X of the vehicle 1.

According to the first embodiment, the lower panel 10 and the upper panel 6 are not attached to each other. In the present case, the upper end of the lower panel 10 forms an undercut, the lower end of the upper panel 6 being arranged in the undercut, at a distance and facing the upper end of the lower panel 10. This is simple and inexpensive means to obtain a front face 2 for which, from the outside, the upper 6 and lower 10 panels appear flush while maintaining the capacity of the lower panel 10 to move independently of the upper panel 6 during an impact. More particularly, in the present case, the undercut forms a groove 11 and the lower end of the upper panel 6 forms a tab 12, also called a dropped edge, arranged in the groove 11. It is understood that the groove 11 and the tab 12 have a general elongated shape along the transverse axis Y of the vehicle 1.

As shown in [FIG. 5], during an impact, the lower panel 10 is moved toward the rear of the vehicle 1, for example along the longitudinal axis X of the vehicle 1. During this movement, the horizontal offset d1 between the lower end of the first external surface 5 and the adjacent upper end of the second external surface 9 is reduced. However, it will be noted that the upper panel 6 and the lower panel 10 are arranged so that, following the movement of the lower panel 10 caused by the impact, a reduced horizontal offset d1′ is still remaining making it possible to conceal any possible unaesthetic technical background from the outside.

The groove 11 and the tab 12 extend in the same substantially horizontal plane when the front face 2 is mounted on the vehicle 1 (FIGS. 4 and 5). Thus, during an impact, the lower panel 10 can be moved rearward along the longitudinal axis X of the vehicle 1 without this movement being disturbed by contacts between the tab 12 and the groove 11. At the same time, it is ensured that the movement of the lower panel 10 does not cause a movement of the upper panel 6, which would risk damaging the trim module 7.

According to a third embodiment shown in [FIG. 7], provision may be made for the lower end of the upper panel 6 to form an undercut forming a groove 11 and that the upper end of the lower panel 10 forms a tab 12 arranged in the groove 11 facing and at a distance from this groove 11. It will be understood that this embodiment offers the same advantages as those of the embodiment described above and differs therefrom only by the inverted positioning of the groove 11 and of the tab 12 passing through the lower 10 and upper 6 panels to the upper 6 and lower 10 panels, respectively.

The arrangement of the upper end of the lower panel 10 relative to the lower end of the upper panel 6 may vary according to the embodiments. Note that it is advantageous that least part of the upper end of the lower portion 4 and/or at least part of the lower end of the upper portion 3 extends in a substantially horizontal plane when the front face 2 is mounted on the vehicle 1. Indeed, as indicated above, such an arrangement allows a movement of the lower panel 10 independently of a movement of the upper panel 6 in order to reduce the risk of damaging the trim module 7 during an impact.

The present disclosure is not limited to the embodiments presented, and other embodiments will become clearly apparent to the person skilled in the art.

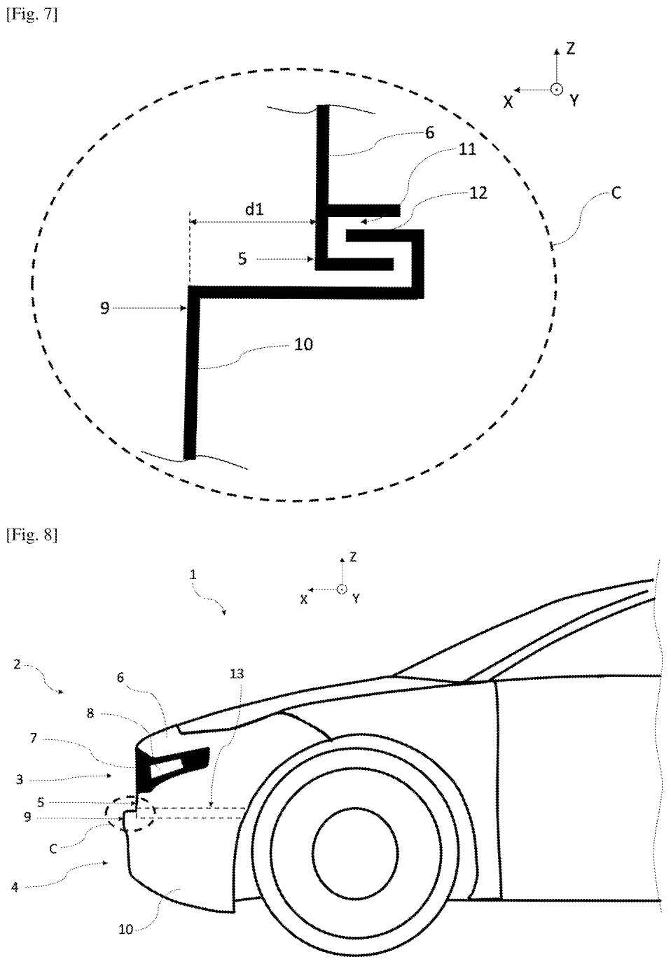

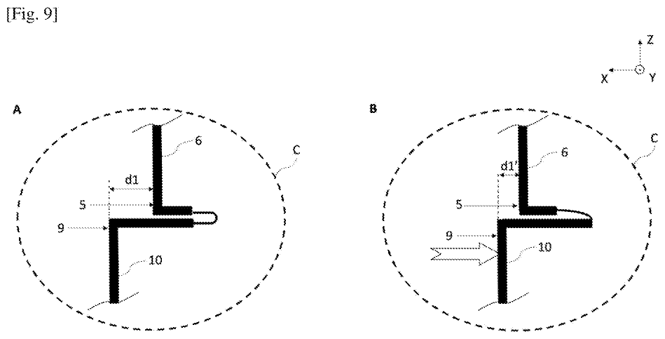

In particular, according to a fourth embodiment shown in FIGS. 8 and 9, the upper panel 6 and the lower panel 10 are integral. Thus, the upper panel 6 and the lower panel 10 form only a single part, which facilitates the integration of the front face 2 on the vehicle 1 and makes it possible to obtain a front face 2 having a continuity of shape, creating an advantageous visual effect.

In the case where the upper 6 and lower 10 panels are integral, provision may also be made for the portion of the front face 2 to the junction between the upper panel and the lower panel to form a connecting zone 13 configured to deform or break during an impact, for example a parking impact, at the second external surface 9 of the lower portion 4. Thus, during such an impact, the connecting zone 13 deforms or breaks easily, allowing the lower portion 4 to move independently of the upper portion 3. For example, according to the fourth embodiment presented, provision may be made for the connecting zone 13 to be more flexible than the rest of the front face 2 by reducing the thickness of the material at the connecting zone 13, thus enabling the lower panel 10 to move independently of the upper panel 6. FIG. 9A shows a configuration before a possible impact. FIG. 9B shows a configuration after or during an impact. It will be noted that the flexible connecting zone 13 deforms during the impact, allowing a movement of the lower panel 10 independently of the upper panel 6. Thus, the lower portion 4 absorbs the deformation or a majority of the deformation due to the impact without this deformation or this impact being passed onto the upper portion 3, thus preserving the latter, and more particularly the trim module 7, from potential damage. The connecting zone 13 can be formed according to any techniques known to the person skilled in the art.

In the case where the upper 6 and lower 10 panels are integral, provision may also be made for the lower panel 10 to be more flexible than the upper panel 6—the upper panel 6 is therefore more rigid than the lower panel 10. Thus, during an impact, for example during a “parking” impact, the force of the impact is sufficient to cause a deformation of the lower panel 10 but is not sufficient to cause deformation of the upper panel 6 if the energy of the impact is partially transmitted from the lower panel 10 to the upper panel 6. The risk of damaging the trim module 7 in the upper panel 6 is thus reduced.

According to another embodiment (not shown), the upper end of the lower panel 10 and the lower end of the lower panel form complementary breakable means for fastening the lower panel 10 to the upper panel 6, configured to break during an impact at the second external surface 9. It may be provided, for example, to fasten the lower panel 10 to the upper panel 6 by clipping, the parts of the lower panel 10 involved in the clipping being configured to break during an impact on the second external face 9. Alternatively, it is possible to use clips attached to the upper end of the lower panel 10 and to the lower end of the upper panel 6, these clips being configured to break during an impact at the second external face 9.

What is claimed is:

1. A front face for a motor vehicle characterized in that it comprises:
an upper portion having a first external surface visible from an outside of the vehicle and comprising an upper panel made of a first plastic material and a trim module, wherein the trim module comprises an electromagnetic waves diffusion member and an external surface transparent or translucent to said electromagnetic waves, wherein the trim module is adapted to attach to a support structure of the vehicle,
a lower portion, having a second external surface visible from the outside of the vehicle and comprising a lower panel made of a second plastic material, an upper end of the lower panel being adjacent to a lower end of the upper panel,
wherein the lower panel is configured to move in a direction of a rear of the vehicle, independently of the upper panel, upon an impact at the second external surface of the lower portion.

2. The front face according to claim 1, wherein the lower panel is configured to move over a stroke of 10 mm to 100 mm along a longitudinal axis (X) of the vehicle, towards the rear of the vehicle, independently of the upper panel.

3. The front face according to claim 1, wherein the upper end of the lower panel and the lower end of the upper panel form deformable or breakable fastening parts, wherein the deformable or breakable complementary fastening parts are adapted to fasten the lower panel to the upper panel, and wherein the deformable or breakable complementary fastening parts are configured to deform or break during an impact at the second external surface of the lower portion.

4. The front face according to claim 1, wherein the upper end of the lower panel forms an undercut, and wherein the lower end of the upper panel being arranged in the undercut at a distance and facing the upper end of the lower panel.

5. The front face according to claim 4, wherein the upper end of the lower panel forms a groove and the lower end of the upper panel forms a tab arranged in the groove.

6. The front face according to claim 1, wherein the lower end of the upper panel forms an undercut, and wherein the upper end of the lower panel being arranged in the undercut at a distance and facing the lower end of the upper panel.

7. The front face according to claim 6, wherein the lower end of the upper panel forms a groove and the upper end of the lower panel forms a tab arranged in the groove.

8. The front face according to claim 5, wherein the groove and the tab extend in a same substantially horizontal plane when the front face is mounted on the vehicle.

9. The front face according to claim 1, wherein the lower portion forms a protuberance relative to the upper portion at an external surface of the front face.

10. The front face according to claim 1, further comprising two optical units integrated into the trim module, the optical units being arranged respectively at two opposite lateral ends of the trim module.

11. A motor vehicle characterized in that it comprises a front face, wherein the front face further comprises:
an upper portion having a first external surface visible from an outside of the vehicle and comprising an upper panel made of a first plastic material and a trim module, wherein the trim module comprises an electromagnetic waves diffusion member and an external surface transparent or translucent to said electromagnetic waves, wherein the trim module is adapted to attach to a support structure of the vehicle,
a lower portion, having a second external surface visible from the outside of the vehicle and comprising a lower panel made of a second plastic material, an upper end of the lower panel being adjacent to a lower end of the upper panel,
wherein the lower panel is configured to move in a direction of a rear of the vehicle, independently of the upper panel, upon an impact at the second external surface of the lower portion.

12. The front face according to claim 2, wherein the upper end of the lower panel forms an undercut, and wherein the lower end of the upper panel being arranged in the undercut at a distance and facing the upper end of the lower panel.

13. The front face according to claim 12, wherein the upper end of the lower panel forms a groove and the lower end of the upper panel forms a tab arranged in the groove.

14. The front face according to claim 13, wherein the groove and the tab extend in a same substantially horizontal plane when the front face is mounted on the vehicle.

15. The front face according to claim 2, wherein the lower end of the upper panel forms an undercut, and wherein the upper end of the lower panel being arranged in the undercut at a distance and facing the lower end of the upper panel.

16. The front face according to claim 15, wherein the lower end of the upper panel forms a groove and the upper end of the lower panel forms a tab arranged in the groove.

17. The front face according to claim 16, wherein the groove and the tab extend in a same substantially horizontal plane when the front face is mounted on the vehicle.

18. The front face according to claim 2, wherein the upper end of the lower panel and the lower end of the upper panel form deformable or breakable complementary fastening parts, wherein the deformable or breakable complementary parts are adapted to fasten the lower panel to the upper panel, and wherein the deformable or breakable complementary fastening parts are configured to deform or break during an impact at the second external surface of the lower portion.

19. The front face according to claim 7, wherein the groove and the tab extend in a same substantially horizontal plane when the front face is mounted on the vehicle.
